(19) United States
(12) Patent Application Publication
(10) Pub. No.: US 2008/0195959 A1
(43) Pub. Date: Aug. 14, 2008

(54) Method Of Constructing Multimedia Scenes Comprising At Least One Pointer Object, And Corresponding Scene Rendering Method, Terminal, Computer Programs, Server And Pointer Object

(75) Inventor: Jean-Claude Dufourd, Le Kremlin Bicetre (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Streamezzo, Paris (FR)

(21) Appl. No.: 11/910,147

(22) PCT Filed: Mar. 27, 2006
(86) PCT No.: PCT/EP2006/061061

§ 371 Date: Feb. 7, 2008

(30) Foreign Application Priority Data
Mar. 29, 2005 (FR) 0503048

(51) Int. Cl. G06F 3/048

(52) U.S. Cl. 715/766

(57) ABSTRACT

A method is provided for constructing multimedia scenes, which are intended to be reproduced on at least one terminal, including at least one multimedia object which can be assigned properties for controlling the behavior thereof in said scene. At least one of the scenes has at least one object, known as the pointer object, which is assigned a pointer property such that it reacts to actions performed by a terminal user, including: at least one action involving the selection of an object and/or the activation of a pre-determined operation that is associated with an object; and at least on action involving the movement of the pointer object, such as to simulate the operation of a pointer on any terminal, even if the terminal is not equipped with corresponding control.

### CROSS-REFERENCE TO RELATED APPLICATION

This Application is a Section 371 National Stage Application of International Application No. PCT/EP2006/061061, filed Mar. 27, 2006 and published as WO 2006/103209 A1 on Oct. 5, 2006, not in English.

### FIELD OF THE DISCLOSURE

The field of the disclosure is that of creating and rendering multimedia scenes, on any type of terminal, and in particular on terminals having an internal operating system (OS) offering all interactivity capabilities available on conventional microcomputers.

### BACKGROUND

More precisely, the disclosure relates to improving the interactivity for such terminals, such as mobile telephones, electronic organisers (PDA), etc.

A multimedia scene, within the meaning of this document, consists of objects each having various characteristics (sizes, colours, animation, content, . . . ), according to known techniques, which in particular have been the subject of standards, e.g., such as SVG (Scalable Vector Graphics, a language for describing vector graphics) or VRML (Virtual Reality Modelling Language).

Such scenes can be programmed by a developer, so as to enable interactivity with the user of a terminal on which they are played. A specific user command can result in a specific action (selection or movement of an object, starting a video, . . . ). These actions or operations can in particular correspond to <<sensors,>> according to VRML or MPEG terminology.

Besides the keypad on microcomputers, the user has a mouse, or similar means, at their disposal, which make it possible to move a pointer on the screen, and to click in order to select an object or start an operation. This interface element is very ergonomic and thus frequently used.

However, although some mobile telephones integrate a similar function, in the form of a stylus or other control device (such as a paddle or <<joystick>>), this technique is far from being made common on small-sized and/or low-cost devices.

In this case, the terminal has neither the interface nor let alone the software means enabling the control of such an interface. In other words, the operating system cannot interpret commands designed for a pointer that it does not possess.

Accordingly, a developer of multimedia scenes wishing to propose a scene capable of being played on any type of terminal has only two solutions, neither of which is satisfactory.

According to a first solution, the scene is developed without using the man-machine interface associated with operating a pointer. The result of this is increased complexity of use and programming, and dissatisfaction on the part of the users of terminals having such an interface.

According to a second solution, two versions of the scene are developed, with and without pointer control. In this case, the production time is of course increased, and the two versions do not react in exactly the same way. Furthermore, it is necessary to provide for a specific control management based on the specific capabilities of the terminal, in order to choose which version to use.

Furthermore, the users of terminals without pointer control have only a degraded version of the scene, which is likely to not satisfy them, and some functions will not be able to be used.

In particular, an exemplary objective of the disclosure is to mitigate these various disadvantages.

More precisely, an exemplary objective of the disclosure is to provide a technique for constructing and rendering multimedia scenes which makes it possible to circumvent the absence of a pointer-type interface control in the operating system of a terminal.

### SUMMARY

An aspect of the disclosure relates to method of constructing multimedia scenes intended to be rendered on at least one terminal, comprising at least one multimedia object to which properties can be assigned, enabling the behaviour thereof to be controlled in said scene.

According to an exemplary embodiment of the invention, at least one of said scenes includes at least one object, referred to as a pointer object, to which a pointer property is assigned such that it reacts to actions carried out by a user of a terminal, including:
at least one action for selecting an object and/or for starting a predetermined operation associated with an object;
at least one action for moving said pointer object, so as to simulate, on any terminal, the operation of a pointer, even if said terminal is not equipped with corresponding control means.

Thus, according to an embodiment of the invention, control of the pointer is not ensured conventionally, by the operating system of the terminal, but by the multimedia scene itself. In a simple and effective way, it is thereby possible to have the use of a pointer, and the associated actions, even on a terminal which does not integrate this function into its operating system.

In other words, control of the pointer is transferred within the scene, which makes it possible to not only have it available for use in a terminal which did not originally have it, but to also develop only one optimised scene for all the terminals.

This approach also remains to be particularly simple: it consists substantially in the creation of a new type of object, or more precisely a new object property for multimedia scenes.

According to a first advantageous approach of an embodiment of the invention, said pointer property can be assigned to any type of object of said multimedia scene having a visual component.

This makes it possible to not only have conventional pointers (arrows, for example), but more generally speaking any type of pointer, including graphic objects, videos . . . without any particular complexity.

According to a second approach of an embodiment of the invention, said pointer property can only be assigned to an object of said multimedia scene of a type belonging to a predetermined selection of object types.

At least one of said actions for moving and/or for selecting is preferably associated with pressing on a keyboard key of said terminal.

Of course, other modes of transmitting actions can be considered, based on the means equipping the terminal (including its own pointer control means, if it has any).

Said scene preferably includes at least one object, referred to as a sensitive object, intended to react with said pointer object, when they are at least partially superimposed.

In order to facilitate detection of this superimposing, it is advantageously provided for said pointer object to include a specific aiming point, referred to as the focal point.

According to one particular embodiment of the invention, said focal point is the origin of a system of local coordinates of said pointer object.

An embodiment of the invention preferably provides for at least one step for superimposing said focal point and a point of one of said sensitive objects.

Said superimposing step is advantageously used for detecting an entry of said pointer onto one of said sensitive objects and/or an exit of said pointer with respect to one of said sensitive objects.

Thus, an entry or an exit can result in transmission of an event corresponding to said sensitive object.

In particular, a selection action carried out during superimposing advantageously results in the transmission of a validation event to the sensitive object concerned.

According to one particular aspect of an embodiment of the invention, it is possible to provide for said movements to be carried out in blocks of N pixels, N being an integer less than the smallest dimension of one of said sensitive objects present in the scene.

Said operations preferably include events corresponding to predetermined action semantics.

In particular, this can involve higher-level actions, such as drag-and-drop, or <<sensors,>> according to VRML terminology.

An embodiment of the invention also relates to signals carrying at least one multimedia scene produced according to the above-described method, and intended to be rendered on at least one terminal.

An embodiment of the invention also relates to computer programs including program instructions for constructing such multimedia scenes.

According to another aspect of an embodiment of the invention, the latter also relates to computer programs including program instructions for running these multimedia scenes.

A program such as this can be installed on a terminal, e.g., in the form of a component to be downloaded (<<plug-in>>), which will complete software already present on the terminal, making it possible to play multimedia scenes.

An embodiment of the invention also relates to multimedia terminals making it possible to render such multimedia scenes, and to the corresponding method of rendering multimedia scenes, already present on the terminal. Of course, it can also be an integral part of such software.

According to yet another aspect, an embodiment of the invention relates to servers containing at least one such multimedia scene, and to data media (disks, storage devices . . . ) carrying such scenes.

Finally, an embodiment of the invention relates to a pointer object of such a multimedia scene. According to an embodiment of the invention, an object such as this is assigned a pointer property such that it reacts to actions carried out by a user of a terminal, including:
at least one action for selecting an object and/or for starting a predetermined operation associated with an object;
at least one action for moving said pointer object, so as to simulate, on any terminal, the operation of a pointer, even if said terminal is not equipped with corresponding control means.

As a clearly identifiable essential constituent, an object such as this is an intermediate component of a multimedia scene according to an embodiment of the invention, which in and of itself has a novel and inventive technical effect.

Other characteristics and advantages will become more apparent upon reading the following description of a preferred embodiment of the invention, given as a single, non-limiting and illustrative example, and from the appended drawings.

### BRIEF DESCRIPTION OF THE DRAWINGS

FIG. 1 shows an example of a terminal, in this case a mobile telephone, rendering a multimedia scene showing a city map and comprising a pointer object according to an embodiment of the invention;

FIG. 2 is a simplified flowchart of a method of constructing multimedia scenes according to an embodiment of the invention;

FIG. 3 is a simplified flowchart of a method of rendering multimedia scenes according to an embodiment of the invention; and

FIG. 4 shows another example of multimedia scenes according to an embodiment of the invention, simultaneously implementing three pointer-type objects.

### DETAILED DESCRIPTION OF ILLUSTRATIVE EMBODIMENTS

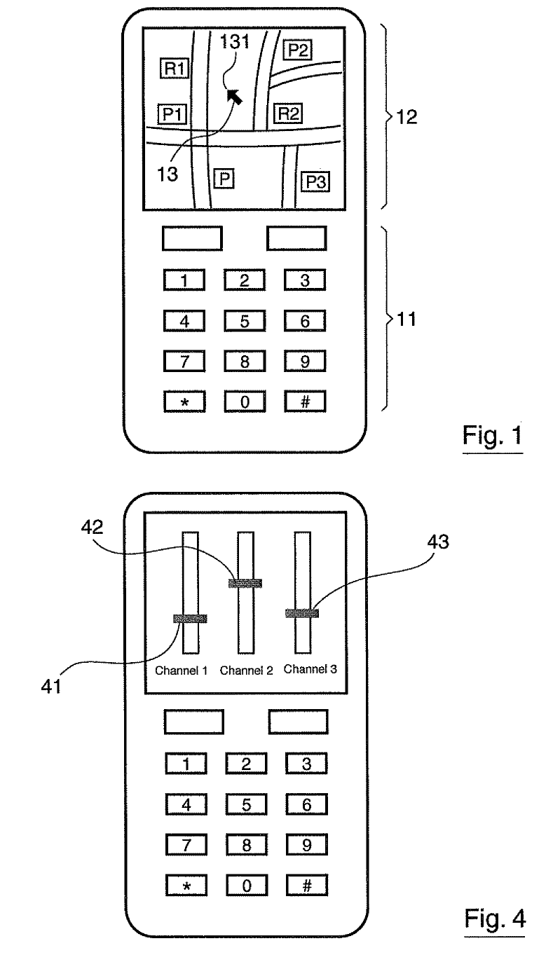

The example of FIG. 1 shows an ordinary mobile telephone, including a keypad 11 and a screen 12, but no means of moving a pointer (stylus, mouse, touch screen . . . ), and no software element, in its operating system, making it possible to control a pointer.

Of course, in its memory, the terminal includes software for rendering multimedia scenes, e.g., in the SVG format, integrating the control of the cursor property according to an embodiment of the invention.

In the example shown in FIG. 1, a multimedia scene has been downloaded. It comprises a map of a city shown at a scale such that two restaurants R1, R2, three parking lots P1, P2, P3 and a post office P are visible on the screen 12. Thus, the map consists of an image and the 6 sensitive objects having a pointer or mouse-type interaction, situated on the restaurants, parking lots and post office.

A polygonal object 13 with seven sides represents an arrow the tip of which is turned upward and to the left. This <<pointer>> object can be moved over the entire screen.

An embodiment of the invention is based on the creation of this pointer object, sensitive objects, and the corresponding control.

Thus, the author of the scene created this arrow object 13 with a specific attribute, for example:

isVirtualPointer=<<true>>.

This attribute gives the arrow object 13 a virtual pointer behaviour. It behaves like the hardware pointer available on the operator systems that support it.

The arrow object 13 has a certain size, and in order for the selection operations to be accurate, one point of the arrow object (in this case the tip of the arrow) is chosen as the focal point 131, i.e., the point situated beneath the tip of the arrow at the top left of the object. This point is the origin of the system of local coordinates of the arrow object, i.e., the coordinate point 0.0.

In order to control the movement of this virtual pointer, the author of the scene has created four actions associated with four keys of the keypad. The key <<2>> triggers an action which moves the arrow object 131 five pixels (for example) upward. In the same way, the keys <<6>>, <<8>> and <<4>> trigger an action which moves the arrow object 13 five pixels towards the right, bottom and left, respectively.

The choice of an increment size of 5 pixels presumes that the sensitive objects are of a size greater than 5 pixels, so that the movement of the virtual pointer does not skip over one of the sensitive objects. In other words, movements are preferably carried out in blocks of N pixels, N being an integer lower than the smallest dimension of the sensitive objects present in the scene.

In order to control the sensitivity of the sensitive objects to the virtual pointer, the multimedia reader verifies, for each movement of the arrow object, whether the focal point of the virtual pointer meets one of the following conditions:
the focal point was not on a sensitive object prior to the movement, and it is situated on a sensitive object after the movement, in which case the reader produces a pointer_entry event and sends it to the object pointed at;
the focal point was on a sensitive object prior to the movement, and it is situated in a non-sensitive area after the movement, in which case the reader produces a pointer_exit event and sends it to the object pointed at previously;
the focal point was on a sensitive object A prior to the movement, and is again situated on a sensitive object B after the movement, in which case the reader produces a pointer_exit event and sends it to the object A, and then produces a pointer_entry event and sends it to the object B.

In the example shown in FIG. 1, when the pointer 13, and more precisely the focal point 131, is superimposed over the restaurant object R1, the latter receives a pointer_entry event, which, for example, can result in a modification of the object such as a change in colours or in size, the display of information (hours of business, menu . . . ). A pointer_exit event results in a return of the object to its previous state.

An embodiment of the invention also makes it possible to emulate a selection operation, or <<click>>. In the example shown, one key of the keypad is by default associated by the reader with validation, e.g., the key <<5>>.

When this key is pressed, the reader verifies whether the focal point of the virtual pointer is situated on one of the sensitive objects. If this is the case, the reader sends a validation event to the object pointed at. For example, the menu for the restaurant R1 is displayed only if this validation event has been received. Other operations (e.g., a telephone call) are of course possible, and are linked solely to programming by the author.

If this is not the case, the reader sends the validation event to the validation manager by default, if the author has defined one.

Several different validation events can of course be defined, and be associated with key combinations, with various keys, with multiple presses (<<double click>>) and/or with the execution of one or more previous operations.

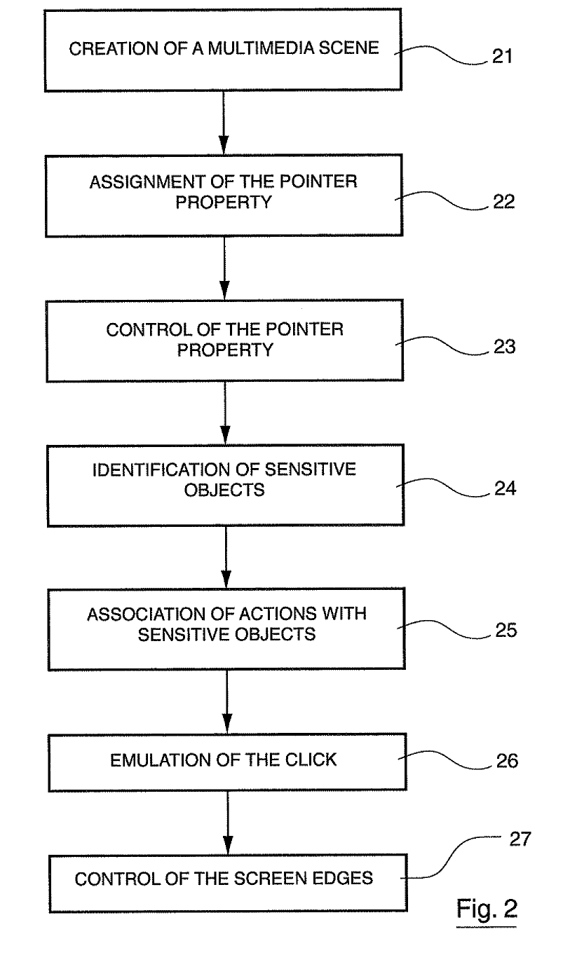

In a simplified manner, FIG. 2 shows a flowchart for implementing the construction method of an embodiment of the invention, via an author, or a developer. The sequencing illustrated by this flowchart is purely indicative: the order of the steps can be modified, steps can be deleted or added, and some of them will generally be implemented simultaneously.

The author first defines 21 a multimedia scene, and in particular a set of objects each having their own properties. Within this framework, he assignes 22 the pointer property isVirtualPointer=<<true>> to one or more objects, and then associates a movement control 23 to each pointer object, e.g., in the form of a movement of N pixels for each pressing of predetermined keys.

Next, the author identifies 24 one or more sensitive objects, and then associates 25 with them actions to be carried out, depending on whether the pointer enters upon, remains on and/or exits from the sensitive object. These actions can be simple, complex and multiple.

In particular, this can involve events corresponding to higher-level action semantics, such as <<drag-and-drop>> or VRML <<sensors>>. For example, passing the pointer over a sensitive object can result in it being set into motion (e.g., rotation of a world map), enable it to be moved (either linearly, in the form of a <<drag-and-drop>> movement, or an any manner (rotation, depthwise movement . . . )), or the starting of a specific operation (opening of another scene, or a menu, starting or stopping a video, . . . ).

The author also programmes 26 the emulation of one or more <<clicks,>> associated when applicable with various objects, and with a default command, when the pointer is not superimposed over a sensitive object.

The author can also programme control of the edges of the image 27, making it possible to move this image when the pointer comes up against an edge of the screen. In the example of FIG. 1, this thereby makes it possible to view another portion of the map. Control of edges and/or corners can also make it possible to associate specific actions with an edge or a corner.

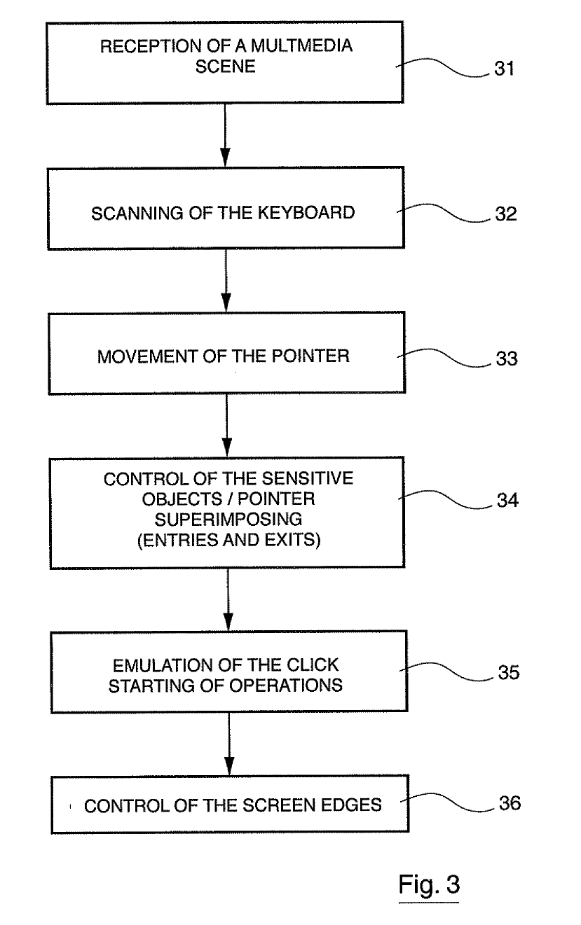

In the same way, FIG. 3 shows the method of rendering a multimedia scene according to an embodiment of the invention, such that it can be implemented, for example, in the terminal of FIG. 1.

The terminal thus receives the scene 31, and the objects which compose it, programmed according to the method of FIG. 2. It then scans the keypad 32, and controls the movement of the pointer object accordingly 33.

It also detects the superimposing 34 of the pointer (more precisely its focal point) and a sensitive object, and produces the operations associated with an entry upon or an exit from a sensitive object.

Finally, it ensures the emulation of a <<click>> 35, or, where applicable, several types of <<clicks>>, and starts the associated operations, based on the position of the pointer.

Numerous alternative implementations can of course be considered.

In particular, the multimedia scene can be anything, provided that it comprises a certain number of objects sensitive to the pointer, like buttons, a form, an image with regions of interest, a game board with bricks or flying saucers . . . .

By way of example, FIG. 4 shows an example relating to a mixing console. Three sound entries are available, and the author has defined three pointer objects 41, 42 and 43, corresponding to cursors. The keys <<1>> and <<7>>, <<2>> and <<8>>, and <<3>> and <<9>> enable the movement of these cursors, respectively. The object to which the author assigns a virtual pointer behaviour can thus be anything, provided that it comprises a visual component: this can be a polygon, an image, a group of polygons, a text, a group of graphic objects, a video . . . .

The focal point of the virtual pointer can be moved anywhere in relation to the visual form of the pointer, e.g., by creating this visual form in a transformation object (like a <g> in SVG).

The choice of the focal point as origin of the system of local coordinates of the pointer object is a simple choice, but any other choice is possible, including a case-by-case choice by explicitly indicating the position of the focal point in the object declared as the virtual pointer, e.g., by a attributefocalPointPosition=<<10 10>.

Of course, the name and the value of isVirtualPointer=<<true>> are replaceable by any unambiguous combination conferring the identical semantics upon a graphic object, or validating such semantics if they are defined by default on all the objects.

The actions ensuring movement of the cursor are not necessarily keystrokes, but any user action via an available means, keypad, special keys, voice recognition, joystick, jog dial/scroll wheel, . . .

The movements of the virtual pointer can be steady or not, isotropic or not, or vary over time or not.

The sensitive objects can be static or moving (as in a game).

The pointer_entry, pointer_exit and validation events can be implemented entirely or partially, and other more complex events can be defined in the same way: distinction between pressing and releasing, <<drag-and-drop>> behaviour, . . . .

An aspect of the disclosure provides a technique for implementing multimedia scenes, which penalises neither users equipped with a terminal having a pointer control, nor users equipped with a terminal not having one.

An aspect of the disclosure provides such a technique, which does not require a developer to develop several versions of the same scene, nor to implement complex development.

An aspect of the disclosure provides such a technique, which can be implemented on the majority of terminals, with or without an integrated pointer control, without any hardware modification, on both new terminals as well as already distributed terminals.

An aspect of the disclosure provides such a technique, which is not costly, whether in terms of processing time or in terms of memory capacity.

Although the present disclosure have been described with reference to one or more examples, workers skilled in the art will recognize that changes may be made in form and detail without departing from the spirit and scope of the disclosure and/or the appended claims.

1. Method comprising:
constructing multimedia scenes intended to be rendered on at least one terminal, comprising at least one multimedia object to which properties can be assigned, making it possible to control the behaviour thereof within said scene, wherein at least one of said scenes includes:
at least one object, said object being assigned a pointer property and a specific aiming point, referred to as a focal point, such that said object reacts to actions carried out by a user of a terminal, including:
at least one action comprising at least one of selecting an object starting a predetermined operation associated with an object; and
at least one action comprising moving said pointer object, so as to simulate, on any terminal, the operation of a pointer, even if said terminal is not equipped with a corresponding controller; and
at least one object, referred to as a sensitive object, which reacts with said pointer object, when they are at least partially superimposed,
wherein said method further comprises superimposing said focal point and a point of at least one of said sensitive objects so as to be able to detect at least one of an entry of said pointer onto the at least one of said sensitive objects or an exit of said pointer with respect to the at least one of said sensitive objects.

2. Method of claim 1, wherein an entry or an exit of said pointer onto or from the at least one of said sensitive objects results in transmission of a corresponding event to said sensitive object.

3. Method as claimed in claim 1, wherein a selection action carried out during said superimposing step results in transmission of a validation event to the sensitive object concerned.

4. Method as claimed in claim 1, wherein said pointer property can be assigned to any type of object of said multimedia scene having a visual component.

5. Method as claimed in claim 1, wherein said pointer property can only be assigned to an object of said multimedia scene of a type belonging to a predetermined selection of object types.

6. Method as claimed in claim 1, wherein said actions for at least one of moving or selecting are associated with pressing on a key of a keypad of said terminal.

7. Method as claimed in claim 1, wherein said focal point is the origin of a system of local coordinates of said pointer object.

8. Method as claimed in claim 1, wherein said movements are carried out in blocks of N pixels, N being an integer less than the smallest dimension of one of the sensitive objects present in the scene.

9. Method as claimed in claim 1, wherein said operations include events corresponding to predetermined action semantics.

10. (cancelled)

11. Computer program carried on a computer readable data medium and comprising program instructions for constructing multimedia scenes intended to be rendered on at least one terminal, comprising at least one multimedia object to which properties can be assigned, making it possible to control the behaviour thereof within said scene, wherein at least one of said scenes includes:
at least one object, said object being assigned a pointer property and a specific aiming point, referred to as a focal point, such that said object reacts to actions carried out by a user of a terminal, including:
at least one action comprising at least one of selecting an object or starting a predetermined operation associated with an object;
at least one action comprising moving said pointer object,
so as to simulate, on any terminal, the operation of a pointer, even if said terminal is not equipped with a corresponding controller; and
at least one object, referred to as a sensitive object, which reacts with said pointer object, when they are at least partially superimposed,
wherein said computer program includes program instructions for executing at least one step of superimposing said focal point and a point of at least one of said sensitive objects so as to be able to detect at least one of an entry of said pointer onto the at least one of said sensitive objects or an exit of said pointer with respect to the at least one of said sensitive objects.

12. Computer program carried on a computer readable data medium and comprising program instructions for executing multimedia scenes intended to be rendered on at least one terminal, including at least one multimedia object to which properties can be assigned, making it possible to control the behaviour thereof within said scene, wherein at least one of said scenes includes:
at least one object, said object being assigned a pointer property and a specific aiming point, referred to as a focal point, such that said object reacts to actions carried out by a user of a terminal, including:
at least one action comprising at least one of selecting an object or starting a predetermined operation associated with an object;
at least one action comprising moving said pointer object,
so as to simulate, on any terminal, the operation of a pointer, even if said terminal is not equipped with a corresponding controller; and
at least one object, referred to as a sensitive object, which reacts with said pointer object, when they are at least partially superimposed,
wherein said computer program includes code instructions for executing at least one step of superimposing said focal point and a point of one of said sensitive objects so as to be able to detect at least one of an entry of said pointer onto at least one of said sensitive objects or an exit of said pointer with respect to the at least one of said sensitive objects.

13. Multimedia terminal enabling the rendering of multimedia scenes intended to be rendered on at least one terminal, comprising at least one multimedia object to which properties can be assigned, making it possible to control the behaviour thereof within said scene, wherein the multimedia terminal includes means for processing, within a multimedia scene:
at least one object, said object being assigned a pointer property and a specific aiming point, referred to as a focal point, such that said object reacts to actions carried out by a user of a terminal, including:
at least one action comprising at least one of selecting an object or starting a predetermined operation associated with an object; and
at least one action comprising moving said pointer object,
so as to simulate, on any terminal, the operation of a pointer, even if said terminal is not equipped with a corresponding controller; and
at least one object, referred to as a sensitive object, which reacts with said pointer object, when they are at least partially superimposed,
wherein said terminal includes means for superimposing said focal point and a point of at least one of said sensitive objects so as to be able to detect at least one of an entry of said pointer onto the at least one of said sensitive objects or an exit of said pointer with respect to the at least one of said sensitive objects.

14. Method comprising:
rendering multimedia scenes on a terminal, said multimedia scenes comprising at least one multimedia object to which properties can be assigned, making it possible to control the behaviour thereof within said scene, wherein at least one of said scenes includes:
at least one object, said object being assigned a pointer property and a specific aiming point, referred to as a focal point, such that said object reacts to actions carried out by a user of a terminal, including:
at least one action comprising at least one of selecting an object or starting a predetermined operation associated with an object;
at least one action comprising moving said pointer object,
so as to simulate, on any terminal, the operation of a pointer, even if said terminal is not equipped with a corresponding controller; and
at least one object, referred to as a sensitive object, which reacts with said pointer object, when they are at least partially superimposed, and
superimposing said focal point and a point of at least one of said sensitive objects so as to be able to detect at least one of an entry of said pointer onto the at least one of said sensitive objects or an exit of said pointer with respect to the at least one of said sensitive objects.

15. (canceled)

16. (canceled)
